(19) United States
(12) Patent Application Publication
(10) Pub. No.: US 2020/0226686 A1
(43) Pub. Date: Jul. 16, 2020

(54) AUTOMATIC IMMUNIZING PORTFOLIO CONSTRUCTION FOR GLIDE PATH LIFECYCLE

(71) Applicant: Goldman Sachs & Co. LLC, New York, NY (US)

(72) Inventor: Frederick Scott McDermott, New York, NY (US)

(21) Appl. No.: 16/734,948

(22) Filed: Jan. 6, 2020

Related U.S. Application Data
(60) Provisional application No. 62/792,960, filed on Jan. 16, 2019.

(51) Int. Cl. G06Q 40/06; G06Q 40/02; G06Q 10/06

(52) U.S. Cl. CPC G06Q 40/06; G06Q 10/0635; G06Q 40/025

(57) ABSTRACT

A portfolio allocation system receives liability data indicating expected future obligations of a pension plan and determines a current value of the future obligations using one or more discount methods. The portfolio allocation system applies a liability risk model to calculate risks associated with the current value. The risks include an interest rate portion and a credit spread portion. The portfolio allocation system determines a proportion of plan capital to dedicate to hedging each of the interest rate portion and the credit spread portion and determines a benchmark for securities to obtain based on the determined proportions. The benchmark may be provided for display to a user in a user interface. The user interface may also include controls for identifying and obtaining securities that are consistent with of the benchmark.

### CROSS REFERENCE TO RELATED APPLICATIONS

This application claims the benefit of U.S. Provisional Application No. 62/792,960, filed Jan. 16, 2019, which is incorporated by reference.

### BACKGROUND

### Technical Field

The subject matter described relates generally to computerized trading systems and, in particular, to generating a benchmark that balances management of interest rate and credit spread risks.

### Background Information

Defined benefit pension plans promise beneficiaries a formulaic benefit, such as an annuity payment based on wage levels and tenure of employment at the plan sponsor or a notional account balance based on wage history and prescribed crediting rates. Often, a plan's current assets are insufficient to meet its projected future obligations; a condition known as an underfunded plan or a plan in deficit. For such plans, the plan fiduciaries are responsible for investing the current assets to sufficiently grow the plan's capital to meet its benefit obligations. One of the considerations when investing the plan's assets is liability risk management. In other words, the fiduciaries seek to minimize the probability that the plan will be unable to fulfil its future obligations, thereby placing the interests of the plan beneficiaries at the forefront.

However, managing risk is difficult. Pension plans are subject to more than one source of risk, and each source is associated numerous variables that are continuously changing with time and market conditions. Furthermore, market-imposed constraints place limitations and costs on possible risk-management strategies. For example, the assets held by a pension plan may be limited by availability and restraints in its governing documents, and any changes in the assets held incur transaction costs, which vary depending on the type of asset. Therefore, manual evaluation of risk is impractical. By the time a human has evaluated the relevant sources of risk and identified potential risk management strategies that are consistent with the plan constraints, market conditions may have changed, perhaps significantly, limiting the value of any conclusions drawn from the earlier data.

Another problem with plan risk management is that actuaries typically produce projections of plan obligations at relatively large time internals (e.g., yearly). Furthermore, these obligations and the associated risks are not intuitively linked to any particular change in the assets held by a plan. While existing systems may produce reports on projected obligations for plans, such reports provide little guidance to plan fiduciaries regarding how to manage the plans over time to minimize their exposure to various risks. Thus, risk management is reliant on the subjective judgments of fiduciaries based on intuition and experience rather than objective criteria.

### SUMMARY

A typical pension plan periodically receives capital from a plan sponsor, such as an employer or group of employers, sometimes augmented by plan participant contributions. Often, the plan's aggregate capital is insufficient to cover future payments to beneficiaries as they retire or otherwise become entitled to their pension. Thus, plan fiduciaries appoint an investment manager to invest the received capital and grow the pension plan's assets. Actuaries periodically (e.g., annually) determine a projected benefit obligation (PBO) indicating the expected future obligations of the pension. More frequently (e.g., daily or weekly), a portfolio allocation system calculates a current value (e.g., a discounted present value) of the expected future obligations and determines how to allocate the plan's assets today in view of the current value of the future obligations. Thus, the portfolio allocation system dynamically balances growing the total value of the plan with hedging against risks associated with market changes.

In various embodiments, the portfolio allocation system divides the plan assets into a growth portfolio and an immunizing portfolio. The growth portfolio is invested to outperform the plan's liabilities over time (e.g., in corporate stocks, etc.) and is typically uncorrelated or only weakly correlated to the plan's liabilities. In contrast, the immunizing portfolio is dedicated to hedging against risks associated with the plan's obligations and is intended to be highly correlated to the plan's liabilities. The immunizing portfolio may be split into credit capital, which is invested to hedge against the credit spread risk of the discounted present value of the plan's liabilities, and completion capital, which is invested to hedge against the plan's interest rate risk and better align the key rate durations of the immunizing portfolio to the interest rate risk of plan liabilities across the range of key rate maturities. The portfolio allocation system may generate a benchmark indicating the properties of assets that the plan manager should purchase or sell to provide a recommended balance between credit spread and interest rate risk hedging in the immunizing portfolio.

In one embodiment, a portfolio allocation system receives liability data indicating expected future obligations of a pension plan and determines a current value of the future obligations using one or more discount methods. The portfolio allocation system applies a liability risk model to calculate risks associated with the current value. The risks include an interest rate portion and a credit spread portion. The portfolio allocation system determines a proportion of plan capital to dedicate to hedging each of the interest rate portion and the credit spread portion and determines a benchmark for securities to obtain based on the determined proportions. The benchmark may be provided for display to a user in a user interface. The user interface may also include controls for identifying and obtaining securities that are consistent with of the benchmark.

### BRIEF DESCRIPTION OF THE DRAWINGS

FIG. 1 is a block diagram of a networked computing environment suitable for enabling management of an investment portfolio, according to one embodiment.

FIG. 2A illustrates the division of an investment portfolio between a growth portfolio and an immunizing portfolio, according to one embodiment.

FIG. 2B illustrates the division of the immunizing portfolio shown in FIG. 2A between completion capital and credit capital, according to one embodiment.

FIG. 3 is a block diagram of the portfolio allocation system shown in FIG. 1, according to one embodiment.

FIG. 4 is block diagram of the data store shown in FIG. 3, according to one embodiment.

FIG. 5 is a flowchart of a method for managing an immunizing portfolio that includes completion capital and credit capital, according to one embodiment.

FIG. 6 is a screenshot of an example user interface displaying information about the weights given to different discount methods, the amount of leverage, and the allocation of immunizing portfolio capital, according to one embodiment.

FIG. 7 screenshot of an example user interface displaying information about the total interest rate risk of the benchmark along with a breakout of key rate durations, according to one embodiment.

FIG. 8 is a graph illustrating the proportions of interest rate risk and credit spread risk that are hedged in an example pension fund, according to one embodiment.

FIG. 9 is a graph illustrating the asymptotic behavior of the immunizing portfolio of the example pension fund, according to one embodiment.

FIG. 10 is a graph illustrating the proportions of the immunizing portfolio allocated to hedging interest rate risk and credit spread risk, according to one embodiment.

FIG. 11 is a graph illustrating the reduction (or increase) in leveraging as the size of the immunizing portfolio increases (or decreases), according to one embodiment.

FIG. 12 is a block diagram illustrating an example computer suitable for use in the network computing environment of FIG. 1, according to one embodiment.

### DETAILED DESCRIPTION

Reference will now be made to several embodiments, examples of which are illustrated in the accompanying figures. Wherever practicable, similar or like reference numbers are used in the figures to indicate similar or like functionality. Although the embodiments described relate to a pension fund, one of skill in the art will recognize that the disclosed techniques may be applied with other types of investment portfolios.

### Example Pension Plan Management Systems

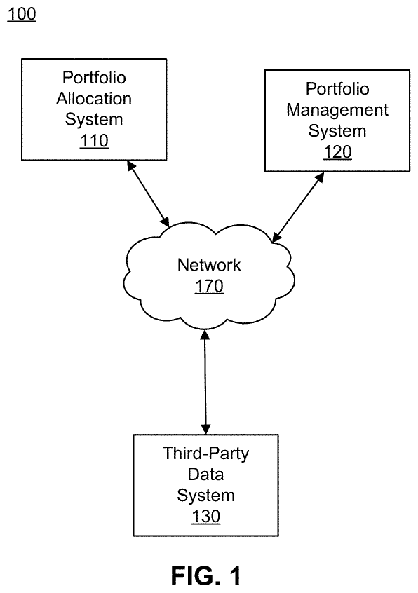

FIG. 1 illustrates one embodiment of a networked computing environment 100 that enables management of a pension plan. In the embodiment shown, the networked computing environment 100 includes a portfolio allocation system 110, a portfolio management system 120, and a third-party data system 130, all connected via a network 170. In other embodiments, the networked computing environment 100 includes different or additional elements. Furthermore, the functions may be distributed among the elements in a different manner than described. For example, the functionality attributed to portfolio allocation system 110 and the portfolio management system 120 may be provided by a single entity.

The portfolio allocation system 110 is one or more computing devices configured to determine recommended allocations for plan assets. The portfolio allocation system 110 retrieves or maintains data for a pension plan. The retrieved data may include current plan assets, liability data describing future plan obligations (e.g., projected liabilities produced by an actuary), and other information about the plan, such as the plan sponsor's tolerance for risk, the likelihood of the sponsor providing (or ability of the plan sponsor to provide) additional plan capital, any investment requirements or limitations for the plan, and any other pertinent information.

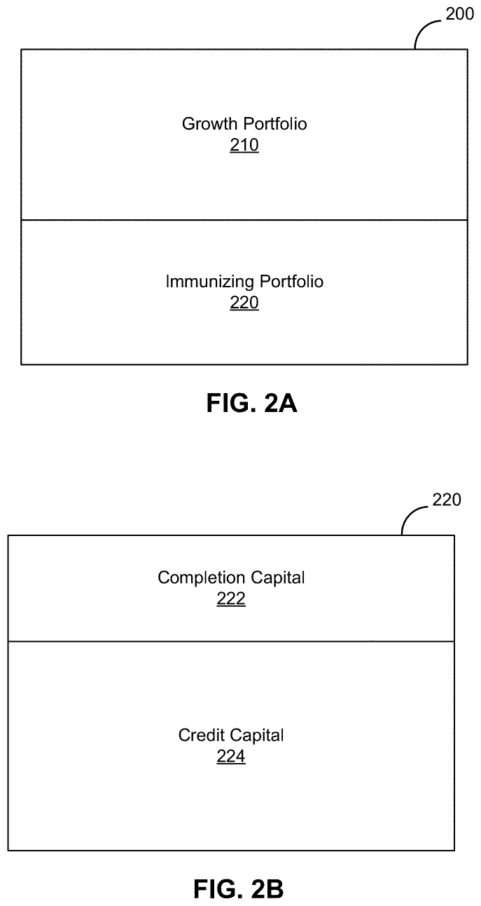

As illustrated in FIG. 2A, the plan has an investment portfolio 200 that is divided into a growth portfolio 210 and an immunizing portfolio 220. The growth portfolio 210 is invested to outperform the plan's liabilities over time. Many plans are underfunded (meaning the plan assets are currently not sufficient to cover the projected plan liabilities). Thus, for such plans, the growth portfolio 210 may be larger than the immunizing portfolio. Generally speaking, the proportion of the plan's assets allocated to the growth portfolio 210 increases with the difference between value of the plan's current assets and its projected future liabilities, with plans that are deeply underfunded (e.g., deeply in deficit) tending to have asset allocations tilting more toward the growth portfolio. Scenarios of the future evolution of the plan deficit are also performed, with the growth portfolio allocation chosen to minimize future plan deficits and future plan sponsor contributions while keeping the possibility of large deficits and large contributions, occurring in adverse future market conditions, to a low level consistent with the risk tolerance and financial strength of the plan sponsor. The precise allocation of the growth portfolio 210 is beyond the scope of this disclosure, but can be determined by a plan manager or other competent party using any other suitable method.

The immunizing portfolio 220 is invested to hedge against risks associated with the projected plan liabilities. Two such risks are the interest rate risk and the credit spread risk. The interest rate risk is a measure of the impact of changes in interest rates on the market value of assets held by the plan and plan liability. The credit spread risk is a measure of the impact of changes in credit spreads on the market value of plan assets and liabilities relating to the likelihood of default for bonds held by the plan and reflective of the extent to which corporate and other credit-sensitive bonds perform higher than U.S. Treasury bonds.

FIG. 2B illustrates one embodiment of an immunizing portfolio 220 that is split into completion capital 222 and credit capital 224. In the embodiment shown, the completion capital 222 primarily provides hedging against the interest rate risk, taking into account the interest rate risk hedged by the credit capital. The completion capital 222 may be distributed to provide a range of rate durations based on (e.g., proportional to) the interest rate risk of plan liabilities over a range of maturity times (e.g., one year, three, years, five years, seven years, etc.). For example, the completion capital 222 may include U.S. Treasury securities and interest rate derivatives such as U.S. Treasury futures. In contrast, the credit capital 224 primarily hedges against the credit spread risk of the plan liabilities (in this embodiment). The credit capital 224 may include credit sensitive assets such as corporate bonds. In the embodiment shown, the entire immunizing portfolio 220 is designated as either completion capital 222 or credit capital 224. In other embodiments, the immunizing portfolio 220 may include additional components, such as a cash reserve or a portion designated to hedging inflation risk. For example, while inflation risk is often de minimis for private-sector pension plans, it may be material in public-sector pension plans where inflation-linked benefits are more common.

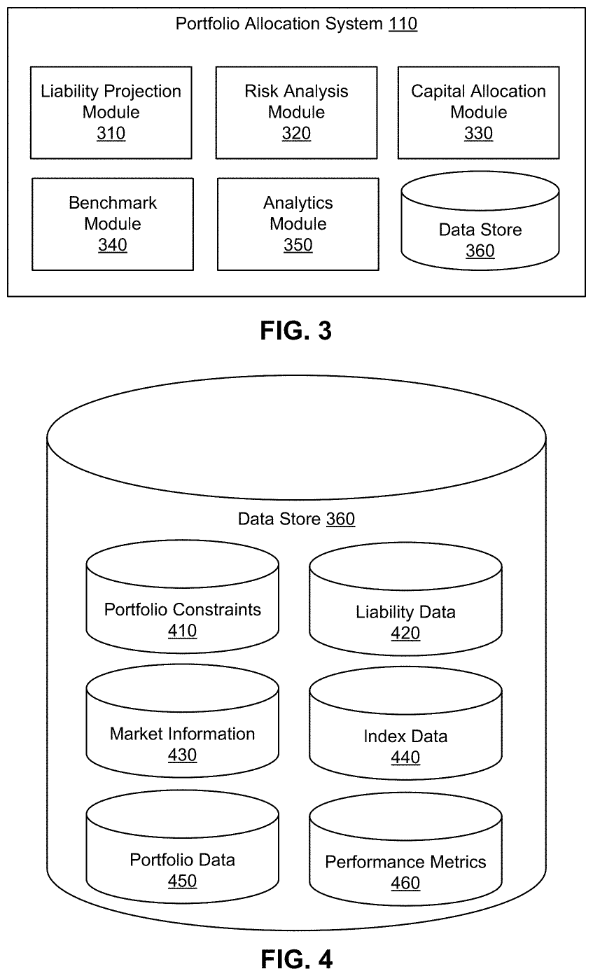

Referring back to FIG. 1, the portfolio allocation system 110 determines a proportion of the total plan assets to include in the growth portfolio 210 and the immunizing portfolio 220. The portfolio allocation system 110 also determines the proportions of the immunizing portfolio 220 to designate as completion capital 222 and credit capital 224. The portfolio allocation system 110 determines a benchmark indicating the properties of securities that should be included in the immunizing portfolio 220 to realize the desired risk-hedging attributes. Various embodiments of the portfolio allocation system 110 are described in greater detail below, with reference to FIGS. 3 and 4.

The portfolio management system 120 provides a user interface (UI) with which a plan manager or trader may view the benchmark generated by the portfolio allocation system 110 and implement trades consistent with the benchmark. The benchmark indicates desired properties of securities for the immunizing portfolio 220 as determined by the portfolio allocation system 110. In one embodiment, the properties include metrics for a range of key rate durations (which may include some key rate durations for which the plan should hold a short position) for the completion capital and credit exposure metrics for the credit capital 224. The benchmark may also indicate a desired amount of leverage for the plan. Thus, the benchmark can be expressed as a leveraged, weighted sum of the plan's projected liabilities discounted on credit and treasury yield curves, with the risks of the resulting leveraged blend set equal to the risks determined by the portfolio allocation system 110 for the desired glide path (e.g., the desired risk management program for the pension plan as it varies over time). In other embodiments, the benchmark may include additional properties, such as a desired convexity. Regardless of the specific properties included in the benchmark, the plan manager or trader may use the UI to obtain securities consistent with the benchmark.

The third-party data system 130 is one or more computing devices that store data used by the portfolio allocation system 110 or portfolio management system 120. For example, the portfolio allocation system 110 may retrieve projected future liabilities of a plan from a third-party data system 130 maintained by the plan sponsor or actuary. As another example, the portfolio management system 120 may access market data indicating securities that are available and current prices and present it to a plan manager or trader. Although only one third-party system 130 is shown in FIG. 1, the networked computing environment 100 may include any number of such systems.

The network 170 can be any type of communications network, such as a local area network (e.g. intranet), wide area network (e.g. Internet), or some combination thereof. The network can also include a direct connection between the portfolio management system 120 and the portfolio allocation system 110. In general, communication between the portfolio allocation system 110 and a portfolio management system 120 can be carried via a network interface using any type of wired or wireless connection, using a variety of communication protocols (e.g. TCP/IP, HTTP, S1v1TP, FTP), encodings or formats (e.g. HTML, JSON, XML), or protection schemes (e.g. VPN, secure HTTP, SSL).

FIG. 3 illustrates one embodiment of the portfolio allocation system 110. In the embodiment shown, the portfolio allocation system 110 includes a liability projection module 310, a risk analysis module 320, a capital allocation module 330, a benchmark module 340, an analytics module 350, and a data store 360. In other embodiments, the portfolio allocation system 110 may include different or additional elements. Furthermore, the functions may be distributed among the elements in a different manner than described.

The liability projection module 310 provides projections of plan obligations. The liability projection module 310 may determine a projected benefit obligation (PBO) of the plan itself or receive a PBO from another system (e.g., an actuary's computer system). Generally, the projected liabilities for the plan are updated periodically over a relatively long timescale (e.g., yearly) although more frequent updates may be used. In one embodiment, the projected liabilities in a PBO include expected benefit obligations each year in the future for a predetermined number of years (e.g., the next 50, 80, or 100 years, etc.). The projected liabilities may include cash flows arising from the plan's final average pay obligations, cash balance plan benefit obligations, and any other type of pension obligation. Thus, the plan obligations may be represented as a set of independent liabilities, each having a type and a year in which it is due.

The risk analysis module 320 periodically calculates the present value of the plan's future obligations and the corresponding risks. The risk analysis module 320 may calculate the present value and corresponding risks more frequently than the liability projection module 310 provides projected future obligations (e.g., daily or weekly). In various embodiments, the liability is characterized by a set of expected future cash flow benefit payment projections. These payment projections may include embedded hedges for cash flow benefit payments that are linked to market variables such as hedges for cash balance plan crediting rates that are indexed to Treasury yields or other market variables (collectively, the “pension liability stream” or “PLS”). The PLS and its effective discount rate may then completely determine the interest rate and credit risk exposures.

In one embodiment, the following variables quantify the PLS and its risk exposures:
PLS_{C}=Present value of the pension liability stream discounted on a Credit yield curve
PLS_{T}=Present value of the pension liability stream discounted on a Treasury yield curve
D_{C,C}=Credit spread duration of PLS_{C}
D_{C,R}=Rates duration of PLS_{C}
D_{T,R}=Rates duration of PLS_{T}
   The PBO can then be expressed as a weighted sum of the pension liability stream discounted on Credit and Treasury yield curves (the “Credit Risk Weight” and “Govt Risk Weight,” respectively) and the risks of those discount methods. The weights may be defined in risk-weighted terms as:
W_{C}=Credit Risk Weight
W_{T}=1−W_{C}=Treasury Risk Weight
   where, by definition:
W_{C}D_{C,C}=Credit spread duration of the blend
W_{C}D_{C,R}+W_{T}D_{T,R}=Interest rate duration of the blend and the present value of the blend can be expressed as:

$$Liability Present Value = PL {S}_{C} ( \frac{{W}_{C} P L {S}_{T}}{\begin{matrix}{W}_{C} P L {S}_{T} + \\ {W}_{T} P L {S}_{C}\end{matrix}} ) + P L {S}_{T} ( \frac{{W}_{T} P L {S}_{C}}{\begin{matrix}{W}_{C} P L {S}_{T} + \\ {W}_{T} P L {S}_{C}\end{matrix}} )$$

where the expressions in parenthesis represent the present value weights of each of PLS_{C} and PLS_{T} in terms of W_{C} and W_{T}. These risk weights hold true not only with the overall credit spread and interest rate risk but also when applied to duration risks at each maturity and credit risks for each credit sector.

The above defines the plan's PBO in terms of the present value of a liability risk model. This generically means that the PBO carries the present value and risk properties of the liability that the pension fiduciaries seek to hedge. The liability risk model can be expressed as a unique set of risk weights W_{C}^{PBO} and W_{T}^{PBO} that satisfy:

$$P B O = P L {S}_{C} ( \frac{{W}_{C}^{P B O} P L {S}_{T}}{\begin{matrix}{W}_{C}^{P B O} P L {S}_{T} + \\ {W}_{T}^{P B O} P L {S}_{C}\end{matrix}} ) + P L {S}_{T} ( \frac{{W}_{T}^{P B O} P L {S}_{C}}{{W}_{C}^{P B O} P L {S}_{T} + {W}_{T}^{P B O} P L {S}_{C}} )$$

and it follows that:

L_{C}=W_{C}^{PBO}D_{C,C}

L_{R}=W_{C}^{PBO}D_{C,R}+W_{T}^{PBO}D_{T,R}

where L_{C} and L_{R} are the credit spread and rates durations of the liability risk model, respectively. In effect, the liability risk model calibrates W_{C} and W_{T} to the actuary's PBO. Thus, the liability risk model can provide a present value of the plan's obligations that is calibrated to the actuary's PBO but that is updated more frequently. For example, the risk analysis module 320 may calculate the current value and corresponding risks (e.g., the credit spread and interest rate risks) daily or weekly based on current market data, while actuaries typically calculate the PBO only annually.

In some embodiments, the risk analysis module 320 stores (e.g., in data store 360) the present value of the plan's obligations as a set of synthetic bonds. For example, the obligations may be represented as a set of zero-coupon bonds; one for each cash flow date of the plan's obligations. The value of each synthetic bond may be the projected obligation for the corresponding date discounted to present value. The risk analysis module 320 may also store information about the corresponding risks in association with the synthetic bonds. Thus, the obligations can be presented in a way that is familiar to traders who need not have any specific experience with pension plan risk management.

The capital allocation module 330 determines how to distribute the plan's assets to hedge against the determined risks. As noted previously, any suitable method may be used to determine the allocation between the growth portfolio 210 and immunizing portfolio 220. This disclosure focuses on determining the allocation of the immunizing portfolio 220 between completion capital 222 (for hedging against the interest rate risk) and credit capital 224 (for hedging against the credit spread risk of the plan liabilities). One or more additional portions of the immunizing portfolio 220 may be allocated to hedge against other risks, such as inflation risk.

In various embodiments, the capital allocation module 330 divides the immunizing portfolio 220 into completion capital 222 and credit capital 224 using a power law relationship. In particular, the objective of the capital allocation module 330 is to determine a split that is consistent with:

$$\frac{ \begin{matrix}Credit Spread Risk of \\ Immunizing Portfolio\end{matrix} }{ \begin{matrix}Credit Spread Risk of \\ Liability Risk Model\end{matrix}} = {( \frac{ \begin{matrix}Rates Risk of \\ Immunizing Portfolio\end{matrix}}{\begin{matrix}Rates Risk of \\ Liability Risk Model\end{matrix}} )}^{N}$$

where the expression on the left represents the credit spread hedge ratio that would be realized if the immunizing portfolio is invested to meet the benchmark and, similarly, the expression in parenthesis on the right is the interest rate hedge ratio that would be achieved. This power law relationship means that the capital allocation module 330 will allocate almost all of the immunizing portfolio 220 to interest rate hedging when capital is scarce and gradually allocate a greater proportion to credit spread hedging as the immunizing portfolio 220 becomes larger. For example, in an embodiment where N=3 a plan hedging 25% of the interest rate risk may hedge only 1.6% of the credit spread risk. Conversely, if the plan is hedging 95% of the interest rate risk it may also hedge 85.7% of the credit spread risk. In other embodiments, other values of N may be used, but the following description assumes N=3 (or approximately 3) for convenience.

For a given plan, the allocation of the immunization portfolio 220 may be defined as:

$$\frac{{D}_{C} \cdot C}{{L}_{C} \cdot PBO} = {( \frac{{D}_{R} \cdot C + {D}_{M} \cdot T}{{L}_{R} PBO} )}^{3}$$

where C is the credit capital 224 (e.g., assets benchmarked to the U.S. Long Credit Index, the U.S. Long Corporate A or Better Index, or another suitable credit benchmark), T is the completion capital 222 (e.g., assets invested in Treasury securities, interest rate derivatives, cash reserves, etc.), D_{C} is a target credit spread duration for the credit capital, D_{R} is a target rates duration for the credit capital, D_{M} is a maximum permitted duration of the completion capital (e.g., 50 years if leverage and interest rate derivatives are permitted or, if no leverage is permitted, the duration of the U.S. 20+ Year STRIPS Index or the U.S. Long Government Index, etc.), PBO is the present value of the liability risk model discounted using a method appropriate for pro-forma financial statements and accounting purposes (the latter of which may serve as a proxy for the market price of plan liabilities), L_{C} is the credit spread duration of the liability risk model, and L_{R} is the rates duration of the liability risk model.

Typically, at any point in time, the liability risk model and its properties (PBO, L_{C}, and L_{R}) are known and determined by the characteristics of the plan. The risk elements (D_{C}, D_{R}, and D_{M}) are also either known or determined by exogenously-imposed constraints such as the permitted investable universe of credit securities (e.g., all investment grade securities or limited corporate A or higher rated securities) and whether and to what extent derivatives and leverage are permitted for the plan. Thus, the two unknowns are the amount of completion capital 222 and credit capital 224. This can be recast as the unknowns being the size of immunizing portfolio 220, IP, and the size of the credit capital 224 in cases where IP=C+T (i.e., when the immunizing portfolio 220 includes only completion capital 222 and credit capital 224).

To simplify the equations for determining the unknowns, normalized variables may be used:
w_{C}=Credit investments as % of immunizing portfolio=C/IP
w_{IP}=Immunizing portfolio as % of present value of liability risk rodel=IP/PBO
R_{C}=Ratio of credit spread durations of credit investments to liability risk model=D_{C}/L_{C}
R_{R}=Ratio of rates durations of credit investments to liability risk model=D_{R}/L_{R}
R_{M}=Ratio of rates durations of completion capital to liability risk model=D_{M}/L_{R}

Using these normalized variables, in the case where N=3 in the power law, the relationship between the size of the immunizing portfolio 220 and the credit capital 224 can be expressed as:

w_{C}Ww_{IP}R_{C}=w_{IP}³[w_{C}R_{R}+(1−w_{C})R_{M}]³

which is equivalent to:

w_{C}³(R_{M}−R_{R})₃−w_{C}²R_{M}(R_{M}−R_{R})²+w_{C}[3R_{M}²(R_{M}−R_{R})+R_{C}/w_{IP}²]−R_{M}³=0

where the only solution with practical meaning has 0≤w_{C}≤1. Note that the capital allocation to the growth portfolio 210 is not included in the above equation. Thus, the capital allocation module 330 may divide the immunizing portfolio 220 into completion capital 222 and credit capital 224 independently from the determination of allocation between the growth portfolio 210 and the immunizing portfolio 220.

The benchmark module 340 generates a benchmark indicating the properties of financial instruments that should be included in the plan's assets to realize the distribution output by the capital allocation module 330. In various embodiments, the benchmark is expressed as a leveraged, weighted sum of the plan's liability stream discounted on credit and Treasury yield curves, with the risks of the resulting leveraged blend targeted to match the determined risks. Alternatively, where leveraging is not used, the benchmark identifies an unleveraged blend matched to the determined risks.

In one embodiment, the determined risks for the immunizing portfolio is expressed as two risk constraints, credit risk matching and interest rate risk matching. The credit risk matching may be defined as:

W_{C}·LVG·D_{C,C}=w_{c}·D_{C}

and the interest rate risk matching may be defined as:

W_{C}·LVG·D_{C,R}+(1−W_{C})·LVG·D_{T,R}+(1−LVG)·D_{F}=w_{C}·D_{R}+(1−w_{C})·D_{M}

where LVG is the benchmark leverage factor (LVG=1 is no leverage) and D_{F} is the duration of the financing cost of leverage in the immunizing portfolio benchmark (typically D_{F} is approximately 0.25, but other values are possible).

Solving these two equations gives the benchmark construction parameters, the benchmark leverage factor, Credit Risk Weight, and Treasury Risk Weight, expressed as:

$${W}_{C} = {w}_{C} \cdot \frac{{D}_{C}}{{D}_{C , C}} \cdot \frac{1}{L V G} = \frac{{w}_{C} \frac{{D}_{C}}{{D}_{C , C}} ( {D}_{T , R} - {D}_{F} )}{\begin{matrix}{w}_{C} {D}_{R} + ( 1 - {w}_{C} ) {D}_{M} + \\ {w}_{C} \frac{{D}_{C}}{{D}_{C , C}} ( {D}_{T , R} - {D}_{C , R} ) - {D}_{F}\end{matrix}}$$

$${W}_{T} = 1 - {W}_{C} = \frac{\begin{matrix}{w}_{C} {D}_{R} + ( 1 - {w}_{C} ) {D}_{M} + \\ {w}_{C} \frac{{D}_{C}}{{D}_{C , C}} ( {D}_{F} - {D}_{C , R} ) - {D}_{F}\end{matrix}}{\begin{matrix}{w}_{C} {D}_{R} + ( 1 - {w}_{C} ) {D}_{M} + \\ {w}_{C} \frac{{D}_{C}}{{D}_{C , C}} ( {D}_{T , R} - {D}_{C , R} ) - {D}_{F}\end{matrix}} \\ L V G = \frac{{w}_{C} {D}_{R} + ( 1 - {w}_{C} ) {D}_{M} + {w}_{C} \frac{{D}_{C}}{{D}_{C , C}} ( {D}_{T , R} - {D}_{C , R} ) - {D}_{F}}{{D}_{T , R} - {D}_{F}}$$

Regardless of how it is generated, the benchmark indicates the target amount of coverage for the portfolio at each of a set of rate durations (e.g., in one embodiment, three months, six months, one year, two years, three years, five years, seven years, ten years, twenty years, thirty years, forty years, and fifty years). The benchmark also indicates an amount of credit hedging assets of different types to obtain for the portfolio, for example corporate bonds of different sectors (e.g., industrial, financial, utility) and maturities, agency bonds, taxable municipal bonds, and credit sensitive debt issued into the U.S. domestic market by supranational, foreign agencies, and foreign local authorities. The benchmark may further indicate additional properties of the target blend of assets, such as convexity and any recommended leveraging. In some embodiments, short positions may be indicated by negative values for the corresponding rate duration or credit hedging asset type. Short positions may be further highlighted by other visual properties, such as the color, size, or position of the corresponding amount when the benchmark is displayed.

In some embodiments, the benchmark module 340 provides the benchmark to a portfolio management system 120 (e.g., via a network 170) for display in a user interface. A portfolio manager may identify financial instruments to buy or sell to align the plan's assets with the benchmark. Because the risk weightings generated by the portfolio allocation system 110 hold true not only with the overall credit spread and interest rate risks, but also when applied to duration risks at each maturity and credit risks for each credit sector, the resulting portfolio may hedge not only the overall risk level but also the key rate durations (assuming that the portfolio manager appropriately matches the benchmark risks at every maturity and for every credit type). In other words, the benchmark may reduce risks associated with parallel shifts in the yield curve, flattening and steepening of the curve, and any convex or concave movements of the yield curve.

The analytics module 350 compares the assets held by the plan during a specified time periods to the corresponding benchmark. In one embodiment, the analytics module generates a report for display that compares the assets of the plan to the benchmark for the rate durations and credit types specified in the benchmark. Thus, a plan manager or other interested party may determine how closely the plan's investments match the benchmark generated by the benchmark module 340.

The data store 360 includes one or more computer-readable media that store data used by the various modules of the portfolio allocation system 110. FIG. 4 illustrates one embodiment of the data store 360. In the embodiment shown, the data store includes portfolio constraints 410, liability data 420, market information 430, index data 440, portfolio data 450, and performance metrics 460. Although the data store 360 is shown as a single entity within the portfolio allocation system 110, the data may be distributed across multiple computer-readable media, some or all of which may be accessed via the network 170. Furthermore, in some embodiments, the data store 360 may include different or additional data.

The portfolio constraints 410 identify the universe of financial instruments that plans may hold. A set of one or more constraints for a plan may be stored in conjunction with an identifier of the plan (e.g., a plan name or number). The constraints 410 may include a blacklist of instruments or classes of instruments that the plan may not hold. Additionally or alternatively, the constraints 410 may include a whitelist of instruments or classes of instruments that the plan may hold. For example, a set of constraints 410 might indicate that, generally, interest rate derivatives may be held but identify one or more specific interest rate derivatives that may not.

The liability data 420 includes projected liabilities of plans. In one embodiment, the projected liabilities are stored as one or more sets of zero-coupon bonds, with each bond corresponding to different cash flow date of the plan's obligations and priced by one or more different discount methods. These bonds need not be tradeable instruments, only representations of tradeable instruments that are used to form a benchmark for an immunizing portfolio composed of tradeable instruments.

Market information 430 includes prices and availability of financial instruments traded on markets. In one embodiment, the UI of the portfolio management system 120 enables the user to query the market information 430 for financial instruments with user-specified properties (e.g., interest rate risk, credit spread risk, etc.) that are currently available along with the corresponding price. The market information 430 may also include historical performance information for financial instruments to provide plan managers and other traders with contextual information regarding past and potential future performance of the instruments.

The index data 440 includes information about the current and historical value of one or more third-party financial market indices. The indices may provide performance information for financial markets as a whole, specific sectors, specific types of instruments, and the like.

The portfolio data 450 includes lists of financial instruments held by one or more plans. The portfolio data 450 may also include histories of the financial instruments held by the plans to enable auditing and analytic analysis. Historical portfolio data 450 may be used to compare the risk profile of the assets held by a plan to the corresponding benchmark over time.

The performance metrics 460 indicate how the plans perform over time. In one embodiment, the performance metric for a plan includes periodic (e.g., daily) difference between the cumulative return of the plan's assets and the cumulative return of a hypothetical portfolio that perfectly matches the plan's benchmark. The periodic differences may be presented by the portfolio management system 120 in a UI. For example, the portfolio management system 120 may plot the cumulative returns by day on the same set of axes. Thus, the area between the lines represents the performance difference of the plan's actual assets versus the benchmark.

### Example Immunization Portfolio Capital Allocation Method

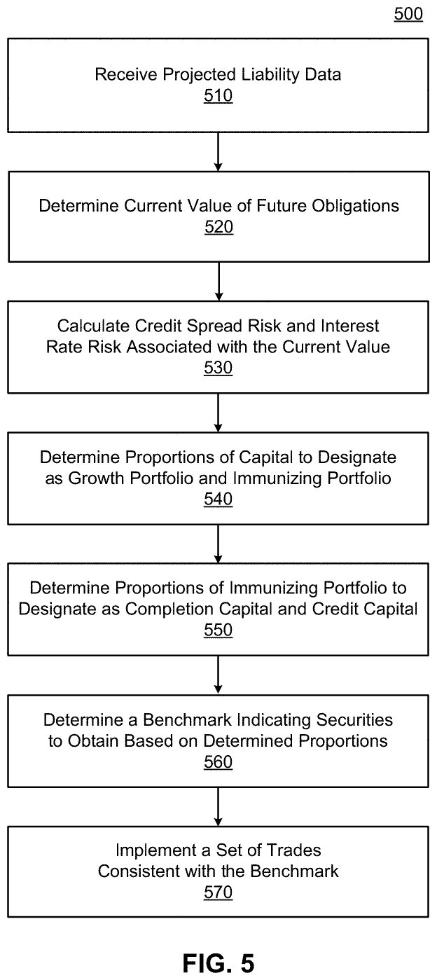

FIG. 5 illustrates an example method 500 for managing an immunizing portfolio. The steps of FIG. 5 are illustrated from the perspective of the portfolio allocation system 110 performing the method 500. However, some or all of the steps may be performed by other entities or components. In addition, some embodiments may perform the steps in parallel, perform the steps in different orders, or perform different steps. For example, trades may be implemented by a separate portfolio management system 120 based on the benchmark generated by the portfolio allocation system 110.

In the embodiment shown in FIG. 5, the method 500 begins with the portfolio allocation system 110 receiving 510 projected liability data. The projected liability data estimates future obligations of the plan to make payments based on factors such as the number of individuals covered by the plan, the age distribution of those individuals, the salaries (or an average salary) of those individuals, predicted mortality rates, and the like. The projected liability data may be provided by an actuary. As described previously, projected liability is typically updated over a relatively long timescale (e.g., annually).

The portfolio allocation system 110 determines 520 the current value of the future obligations indicated by the liability data. Any appropriate method for calculating the current value of a future obligation may be used. As described previously, the portfolio allocation system 110 may determine 520 the current value of future obligations more frequently than the future obligations themselves using current market data. For example, the current value may be updated hourly, daily, weekly, etc. The portfolio allocation system 110 also calculates 530 the credit spread risk and the interest rate risk associated with the current value of the plan's future obligations.

The portfolio allocation system 110 determines 540 the proportions of the plan's capital to designate as the growth and immunizing portfolios. As described previously, any suitable method may be used for this. The portfolio allocation system 110 also determines 550 the proportions of the immunizing portfolio to designate as completion and credit capital. Example approaches to determining 550 how to split the immunizing portfolio into completion capital and credit capital are described above with reference to capital allocation module 330.

The portfolio allocation system 110 determines 560 a benchmark indicating securities to obtain based on the determined proportions. As described previously, the benchmark indicates desired properties of securities for the immunizing portfolio. For example, the properties may include metrics for a range of key rate durations for the completion capital and credit exposure metrics for the credit capital. The benchmark may also indicate target leverage for the plan.

The plan's assets are updated by implementing 570 a set of trades consistent with the benchmark. In one embodiment, a trader uses a UI that displays the benchmark to select trades to make based on the benchmark. The UI may include tools to aid the trader in identifying available assets with specified properties to enable the trader to build a portfolio with similar properties to those indicated by the benchmark. In other embodiments, some or all of the trades may be implemented automatically or semi-automatically. For example, the portfolio allocation system 110 may attempt to automatically identify a set of assets with the properties indicated by the benchmark (within a threshold degree of tolerance) and notify a trader if the automated identification fails to enable the trader to use their judgment in selecting appropriate assets that match the benchmark as closely as possible.

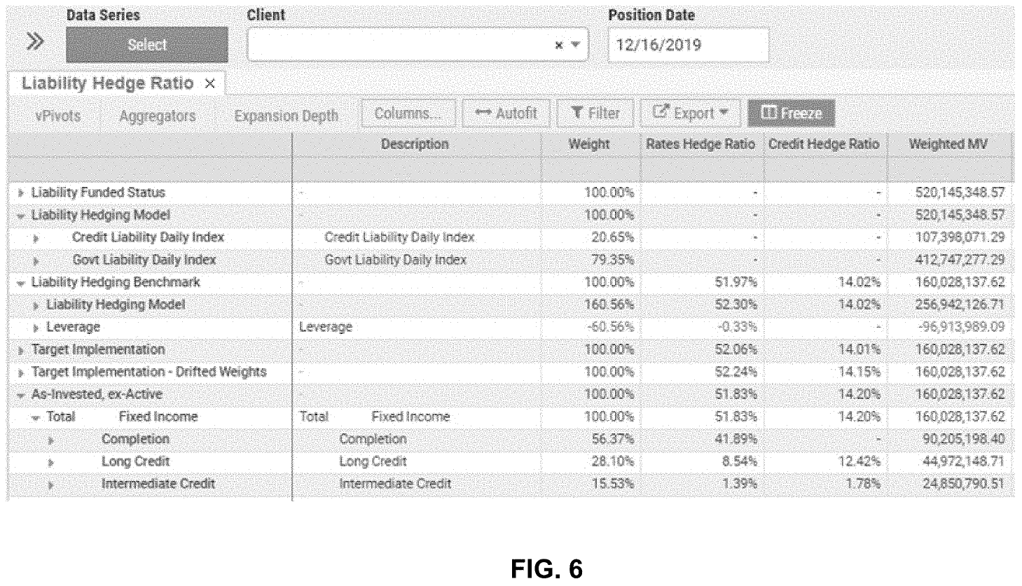

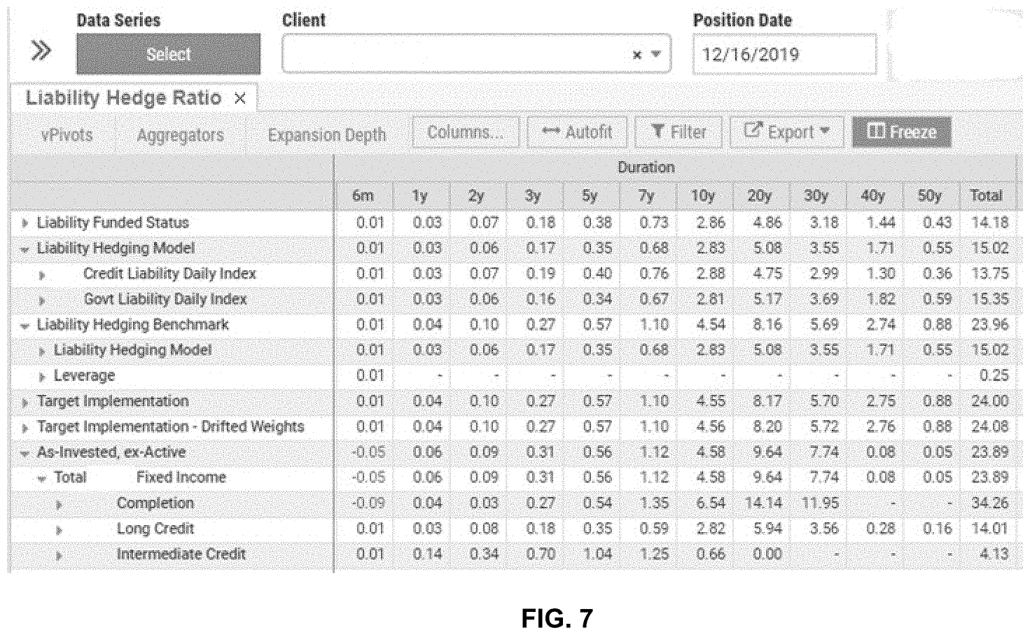

FIGS. 6 and 7 are screenshots of an example UI displaying information about the immunizing portfolio 220. In FIG. 6, the example UI includes weights given to different discount methods, the amount of leverage, and the allocation of immunizing portfolio capital. in particular, the upper half of UI shows output from the benchmark module 340 including the weights applied to the credit (Credit Risk Weight) and government (Treasury Risk Weight) discount methods and the leverage (LVG) applied. The lower half of the UI shows information about the immunizing portfolio 220, specifically the division between completion capital 222 and credit capital 224. The credit capital 224 is divided into two maturity ranges, along with the realized interest rate and credit spread hedge ratios. In FIG. 7, the UI is displaying information about the total interest rate risk of the benchmark and immunizing portfolio 220 along with a breakout of key rate durations for different maturity buckets (e.g., six months, one year, two years, . . . , etc.). As described previously, short positions may be highlighted by modifying one or more visual properties of the corresponding cells in the table, such as the color, size, or position of the corresponding amount. For example, in FIG. 7, short positions may be displayed in red while other positions are displayed in black.

### Example Pension Plan

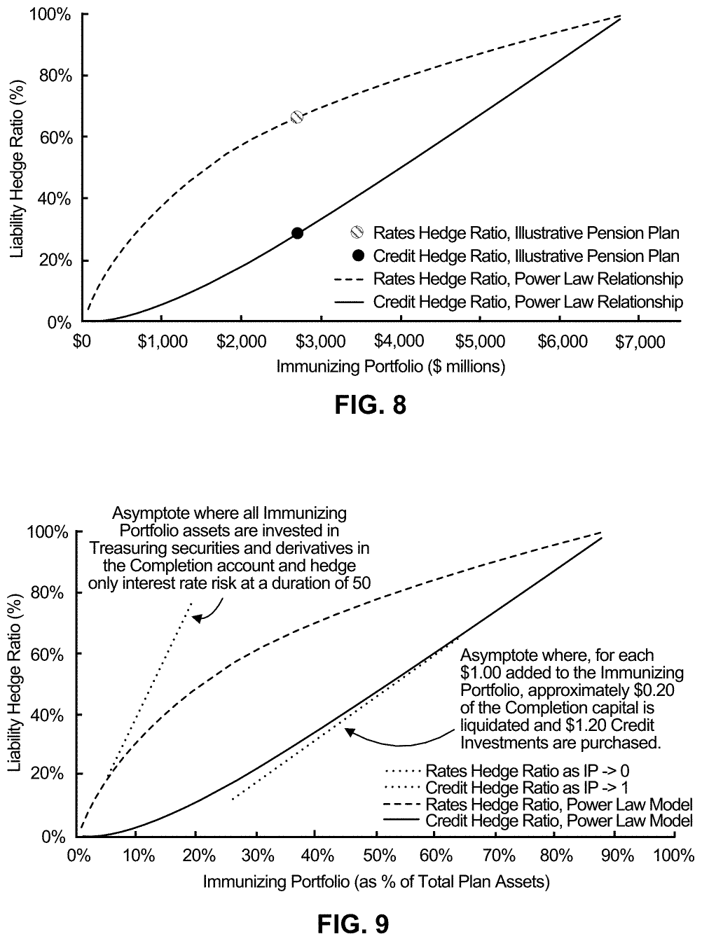

FIGS. 8 through 11 illustrate application of some of the disclosed techniques an example pension plan to aid understanding. The example uses the disclosed power law relationship with the following parameters:

N=3

IP=$2,696,001,812

C=$2,022,386,689

T=$673,616,123

D_{C}=13.8338 years

D_{R}=13.3756 years

D_{M}=50 years

PBO=$7,427,883,413

L_{C}=12.4432 years

L_{R}=13.1965 years

W_{IP}=0.3629569369

R_{C}=1.1117568616

R_{R}=1.0135729202

R_{M}=3.7888834181

In one embodiment, these parameters result in the following immunizing portfolio:

IP Assets: $2,696,001,812

IP as % of total plan assets: 35.1%

Credit Weight in IP (w_{c}): 71.1%

Credit Capital: $1,915,736,495

Completion Capital: $780,265,317

Credit Risk Hedge Ratio: 28.7%

Interest Rate Risk Hedge Ratio: 65.9%

The power law relationship may be used to project the example pension plan's future glide path for immunizing portfolio asset allocation and liability hedge ratios. FIG. 8 illustrates the projected glide path for the example pension plan, specifying the percentages of the credit and interest rate risks hedged as a function of the immunizing portfolio capital. As can be seen in FIG. 8, when the immunizing portfolio is small, the majority of risk hedging is focused on the interest rate risk. As the size of the immunizing portfolio increases, the proportion of the credit risk that is hedged begins to catch up until, eventually, both risks are fully hedged.

FIG. 9 illustrates the behavior of the immunizing portfolio at the asymptotes where the immunizing portfolio has a size of zero and, conversely, where the plan is fully hedged. At the limit where the immunizing portfolio shrinks towards zero, interest rate risk management dominates. Insufficient capital exists to hedge credit risk in any material way, and the Immunizing Portfolio asymptotes to just being a completion program (i.e., the liability hedging program becomes, effectively, a long Treasury STRIPS portfolio or derivatives overlay, hedging only interest rate risk). Mathematically:

Rates Hedge Ratio|_{Limit IP→0}=R_{M}w_{IP}

which scales linearly with the leverage taken in the completion capital account.

At the opposite limit, where immunizing portfolio capital makes up the bulk of the pension plan's investments, the growth portfolio shrinks towards zero, and credit risk management is playing “catch up” to interest rate risk management. The rate of increase in credit investments per unit increase in IP capital can be expressed as:

$$\frac{δ C}{δ IP} {\vert}_{Limi t G P \to 0} = \frac{3 {{R}_{M} [ {w}_{C} ( {R}_{M} - {R}_{R} ) - {R}_{M} ]}^{2}}{3 {( {R}_{M} - {R}_{R} ) [ {w}_{C} ( {R}_{M} - {R}_{R} ) - {R}_{M} ]}^{2} + RC \text{/} {FS}^{2}}$$

where FS is the funded status of the plan, specificallyFS=Plan Assets/PBO and is equivalent to the variable W_{IP} in the limit where immunizing portfolio capital is increasing and GP→0. As can be seen in FIG. 9, once the rates hedge ratio has reached approximately 50% to 60%, then for every $1.00 in capital added to the immunizing portfolio, the completion capital is reduced by approximately $0.20 and the Credit investments are increased by approximately $1.20. Note that the specific values shown in FIG. 9 are specific to the example pension plan, but the principle of preferentially hedging interest rate risk when IP capital is scarce and layering in credit risk management as IP capital increases in generally applicable.

The plan is fully hedged when Rates Hedge Ratio=Credit Hedge Ratio=100%, or when w_{C}w_{IP}wR_{C}=1 and w_{IP}[w_{C}R_{R}+(1−w_{C})R_{M}]=1 are both true simultaneously. Solving these equations for w_{C} and w_{IP} gives:

$${IP}_{FullyHedged} = PBO ( \frac{1}{{R}_{M}} + \frac{1}{{R}_{C}} + \frac{{R}_{R}}{{R}_{M} {R}_{C}} ) and$$

$${w}_{C FullyHedged} = \frac{{R}_{M}}{( {R}_{M} - {R}_{R} + {R}_{C} )}$$

where IP_{Fully Hedged} is the immunizing portfolio capital required for the plan liability to be fully hedged and w_{C Fully Hedged} is the fraction of that capital invested in credit securities.

If the example pension plan does not allow derivatives and is fully hedged, where R_{M}→R_{R}, then:

$${IP}_{FullyHedged} \to PBO \frac{{L}_{R}}{{D}_{R}}$$

contingent on:

$$\frac{{D}_{R}}{{D}_{C}} \leq \frac{{L}_{R}}{{L}_{C}}$$

where the latter contingency enforces the practical limit that w_{C Fully Hedged}≤1. This is a rule-of-thumb limit and not an exact equation since, in the practical world and unless corporations suddenly start issuing debt at much longer maturities than, or without credit spread to, the debt of risk-free sovereigns, R_{M} will be slightly greater than R_{R} because of convexity effects even if only physical debt securities are used in the immunizing portfolio implementation.

For the Illustrative Pension Plan example where R_{M}=50, IP_{Fully Hedged}=92.3% of the PBO and w_{C Fully Hedged}=97.5%. In a “no derivatives” example pension plan where R_{M}→R_{R}, then IP_{Fully Hedged} rises to 98.7% of the PBO. Absent considerations of the present value of future service costs, this level of immunizing portfolio capitalization represents the end of the asset allocation glide path.

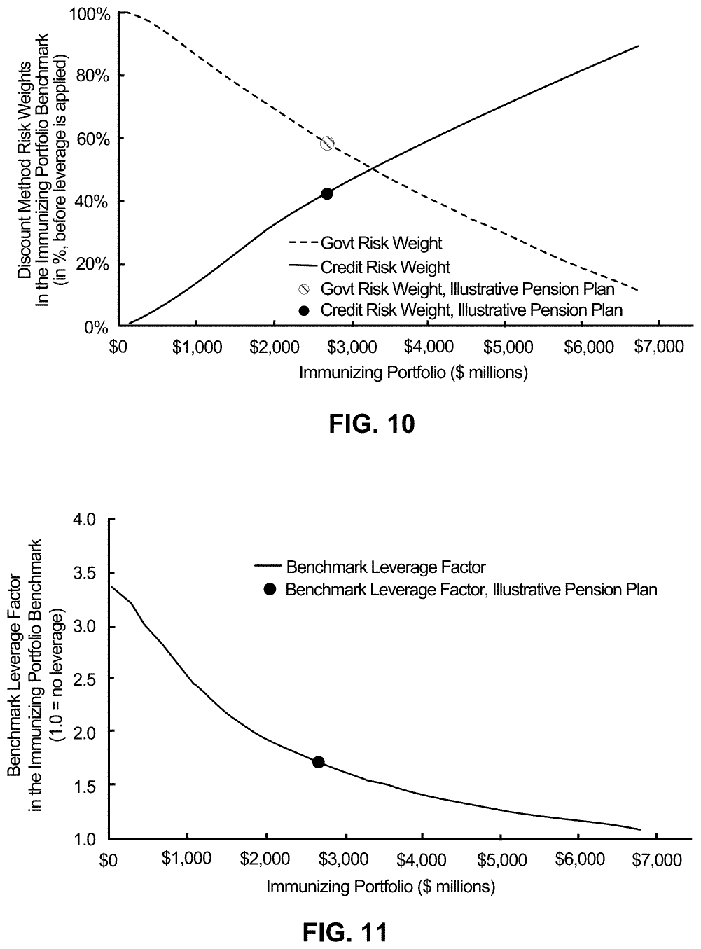

FIG. 10 illustrates the glide path for the credit and treasury risk weights and FIG. 11 illustrates the glide path for the benchmark leverage factor for the example pension plan. As expected, the first $1 allocated to the immunizing portfolio is invested in completion capital devoted to interest rate risk management. Leverage is high. In this case, leverage is limited only by the maximum duration at which the completion capital can operate, which is generally set to maintain sufficient capital reserves for margin purposes (or, when derivatives are not used, by the longest duration Treasury securities available in the marketplace), but other limitations may be placed on leverage. Leverage drops quickly as immunizing portfolio capital increases and credit investments begin to appear in a material way. Additional credit investments soon absorb both all new capital added to the immunizing portfolio and some additional capital freed up by liquidation of a portion of the completion capital. Leverage may drop to de minimis values when immunizing portfolio capital is plentiful and the plan approaches a fully-hedged state.

### Example Computing Device Architecture

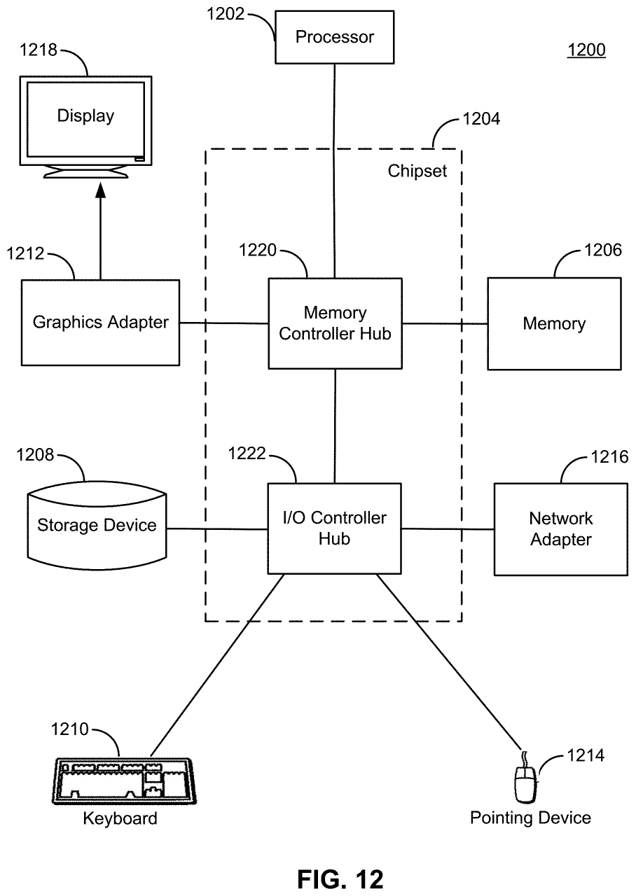

FIG. 12 illustrates an example computer 1200 suitable for use as a portfolio allocation system 110, portfolio management system 120, or a third-party data system 130. The example computer 1200 includes at least one processor 1202 coupled to a chipset 1204. For clarity, operations may be described as being performed by “a processor,” but this should be understood to include multiple processors working cooperatively to perform the recited operations. The chipset 1204 includes a memory controller hub 1220 and an input/output (I/O) controller hub 1222. A memory 1206 and a graphics adapter 1212 are coupled to the memory controller hub 1220, and a display 1218 is coupled to the graphics adapter 1212. A storage device 1208, keyboard 1210, pointing device 1214, and network adapter 1216 are coupled to the I/O controller hub 1222. Other embodiments of the computer 1200 have different architectures.

In the embodiment shown in FIG. 12, the storage device 1208 is a non-transitory computer-readable medium such as a hard drive, compact disk read-only memory (CD-ROM), DVD, or solid-state memory device. The memory 1206 holds instructions and data used by the processor 1202. While the storage device 1208 is shown to be a single medium, the term “machine-readable medium” should be taken to include a single medium or multiple media (e.g., a centralized or distributed database, or associated caches and servers) configured to store data or software used by the computer 1200.

The pointing device 1214 is a mouse, track ball, touch-screen, or other type of pointing device, and is used in combination with the keyboard 1210 (which may be an on-screen keyboard) to input data into the computer system 1200. The graphics adapter 1212 causes the display 1218 to display images and other information. The network adapter 1216 couples the computer system 1200 to one or more computer networks, such as network 170.

The types of computers used by the entities of FIGS. 1, 3, and 4 can vary depending upon the embodiment and the processing power required by the entity. For example, a third-party data system 130 might include a distributed database hosted on multiple servers that work together to provide the functionality described. Furthermore, the computers can lack some of the components described above, such as keyboards 1210, graphics adapters 1212, and displays 1218.

### Additional Considerations

Embodiments of the disclosed portfolio allocation system 110 and portfolio management system 120 can determine benchmarks for pension plans. Unlike prior solutions, these benchmarks may provide objective criteria for managing the risks associated with the pension plan. The disclosed approaches are different from conventional risk management approaches adopted by humans because the disclosed approaches are impractical to perform in the human mind or using pen and paper because of the complexity of the calculations involved and the speed at which market conditions may evolve. Furthermore, the benchmark represents a risk management strategy in a way that is easily understood by traders without the need for additional specialized training.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate alternative structural and functional designs for a system and a process for managing a pension plan. For instance, server processes may be implemented using a single server or multiple servers working in combination, databases and applications may be implemented on a single system or distributed across multiple systems, and distributed components may operate sequentially or in parallel. Thus, while particular embodiments and applications have been illustrated and described, the scope of protection should be limited only by the following claims.

What is claimed is:

1. A method comprising:
receiving liability data indicating expected future obligations of a pension plan;
determining a current value of the future obligations using one or more discount methods;
applying a liability risk model to calculate risks associated with the current value, the risks including an interest rate portion and a credit spread portion;
determining a proportion of plan capital to dedicate to hedging each of the interest rate portion and the credit spread portion;
determining a benchmark for securities to obtain based on the determined proportions; and
providing, for display to a user, a user interface including the benchmark.

2. The method of claim 1, further comprising implementing a set of trades consistent with the benchmark.

3. The method of claim 1, wherein determining the proportion of plan capital to dedicate to hedging each of the interest rate portion and the credit spread portion comprises:
determining a proportion of plan capital to designate as an immunizing portfolio; and
determining a proportion of the immunizing portfolio that is completion capital and a proportion that is credit capital, wherein the completion capital is used primarily to hedge the interest rate risk and the credit capital is used primarily to hedge the credit spread risk.

4. The method of claim 3 wherein the model uses a power law relationship defined as:
$$\frac{Credit Spread Risk of Immunizing Portfolio}{Credit Spread Risk of Liability Risk Model} = {( \frac{Rates Risk of Immunizing Portfolio}{Rates Risk of Liability Risk Model} )}^{N}$$

5. The method of claim 4, wherein N=3.

6. The method of claim 2, wherein at the limit where a size of the immunizing portfolio tends to zero, a majority of new capital added to the immunizing portfolio is designated as completion capital.

7. The method of claim 6, wherein as the size of the immunizing portfolio increases, an increasing proportion of the immunizing portfolio is designated as credit capital.

8. The method of claim 1, wherein liability data is periodically received at a first timescale and the current value of the future obligations is periodically determined at a second timescale, shorter than the first timescale.

9. The method of claim 8, wherein the first timescale is annually and the second timescale is daily.

10. The method of claim 1, wherein the benchmark is expressed as a leveraged, weighted sum of the expected future obligations discounted on credit and treasury yield curves, with the risks of the leveraged weighted sum matching the calculated risks associated with the current value.

11. The method of claim 1, wherein the benchmark indicates a target amount of coverage at each of a set of key rate durations.

12. The method of claim 1, wherein the benchmark indicates an amount of credit hedging assets of different types to obtain.

13. The method of claim 1, wherein the benchmark indicates at least one of recommended convexity or recommended leveraging.

14. The method of claim 1, wherein the user interface further includes controls to enable the user to identify available securities with one or more desired properties.

15. The method of claim 1, wherein the user interface further includes controls to enable the user to obtain one or more securities.

16. The method of claim 1, wherein the risks further include an inflation risk, the method further comprising determining a proportion of plan capital to hedging the inflation risk.

17. The method of claim 1, wherein the expected future obligations are stored as one or more sets of zero-coupon bonds, with each bond corresponding to different cash flow date of the pension plan's obligations priced by one or more different discount methods.
